(19) United States
(12) Patent Application Publication
(10) Pub. No.: US 2007/0157289 A1
(43) Pub. Date: Jul. 5, 2007

(54) Resticting access to cookies

(75) Inventors: Philip Steven Newton, Eindhoven (NL); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,879

(22) PCT Filed: Feb. 1, 2005
(86) PCT No.: PCT/IB05/50425

§ 371 Date: Aug. 10, 2006

(30) Foreign Application Priority Data
Feb. 16, 2004 (EP) 04100613.1

(51) Int. Cl. H04L 9/32

(52) U.S. Cl. 726/2

(57) ABSTRACT

The present invention relates to a method of restricting access to cookie information stored on a client, said client being communicatively connected to servers via a public communication network, wherein the client receives first party data from said server, said first party data comprising embedded links to third party web pages, where at least one of said web pages is adapted for storing client specific cookie information relating to said third party web page on said client, the method comprises the step of: restricting access to said stored cookie information, whereby only third party web pages have access to said cookie information if the third party web pages are accessed via a link from said first party data.

The present invention relates to a method of restricting access to cookie information stored on a client, said client being communicatively connected to servers via a public communication network. The invention further relates to a computer readable medium causing a processing unit to execute the method. Further, the invention relates to a client adapted for being communicatively connected to servers via a public communication network adapted for restricting access the cookie information stored on the client.

MHP is a standard for interactive TV that specifies the functionality available to applications that are designed to operate on devices that support MHP. MHP is based on the Java platform. It extends the Java platform with libraries specific to a digital interactive TV platform. MHP is typically designed for use on Set Top Boxes (STB). The current version of the standard does not provide functionality for recording applications and audio/video content. It is based solely on live broadcast.

In the upcoming new version of the Multimedia Home Platform 2.0 (MHP) PDR (Personal Digital Recorder) functionality will be integrated. For MHP applications that will make use of this new functionality it means that they will be able to make recordings, obtain information on stored programmes and obtain background information on the content. MHP applications can also be recorded themselves and will have access to its own data files.

Another part of the standard that will have an impact on the recording of the MHP applications is the existence of a return channel. The return channel will consist of an Internet connection through which an application can send information back to the broadcaster. This can be used for E-commerce, Games, Gambling, etc.

Of course this Internet connection can also be used to obtain additional information. The information coming from the Internet connection can be used to add to the broadcast content for making the viewing experience truly dynamic and interactive.

When accessing the Internet, websites typically use the concept of cookies to track the user access to their website. This system can be abused to gather information on which websites a user has visited.

In US2003/0061275 a system for removing and saving in an intermediary web server Internet cookies being transmitted from a web content server to a client device is described. To protect the security of the cookies and to allow an authorised user to use the cookies from multiple devices, such as on different desktop computers, PDA's or cellular telephones, the cookies are removed from the data response from the web content server and stored in an intermediate web server, where they are accessible to the user. The system does not solve the problem of different websites having access to the same set of cookies, whereby cookies comprising information from a first website can be accessed by a second website. The protection of user privacy is not obtained.

It is therefore an object of the present invention to solve or alleviate the above-mentioned problems.

This is obtained by a method of restricting access to cookie information stored on a client, said client being communicatively connected to servers via a public communication network, wherein the client receives first party data from said server, said first party data comprising embedded links to third party web pages, where at least one of said web pages is adapted for storing client specific cookie information relating to said third party web page on said client, the method comprises the step of:
restricting access to said stored cookie information, whereby only third party web pages have access to said cookie information if the third party web pages are accessed via a link from said first party data.

Thereby the server providing the first party data or the third party service providers can only see the cookie information related to the first party data and not to the data of other parties. This avoids tracking users viewing by third part web pages linked from within the first party data. The first party data could e.g. be a broadcasted application or a web page. The client could be a multimedia home platform MHP, or it could be a standard home computer. The server could be a broadcaster, or it could be web provider.

In a specific embodiment the access to said cookie information is restricted by tagging the stored cookie information with an ID of the first party data, whereby the ID is used to ensure that only third party web pages accessed via a link from said first party data have access to the cookie information.

This is an easy way of restricting access to data and a number of different identification methods relating to network communication which can be used are available.

In an embodiment the access to said cookie information is restricted by generating a specific cookie file, whereby only third party web pages being accessed via a link from said first party data have access to said cookie file.

By generating a single cookie file only access to this file needs to be authorised. This results in both a faster authorisation process and also a less resource demanding process.

In an embodiment the first party data is a web page. Web pages often contain a number of advertisement links to other web pages. By restricting access to their cookie files according to the invention it will not be possible to track where the user has been.

In an embodiment the first party data is a broadcasted channel. Thereby it can be used in connection with MHP clients receiving broadcasted applications.

In an embodiment the client is a MHP client, and wherein the identification system of the MHP used for identifying the server, such as a broadcaster, is further used for checking whether a third party application has access to said cookie information.

The invention further relates to a computer readable medium having stored therein instructions for causing a processing unit to execute the above method.

The invention further relates to a client adapted for being communicatively connected to servers via a public communication network, wherein the client is adapted for receiving first party data from said server, said first party data comprising embedded links to third party web pages, where at least one of said web pages is adapted for storing client specific cookie information relating to said third party web page on said client, the client comprises:
means for restricting access to said cookie information, whereby access to said cookie information is restricted to third party web pages being accessed via a link from said first party data.

In the following preferred embodiments of the invention will be described referring to the figures, where

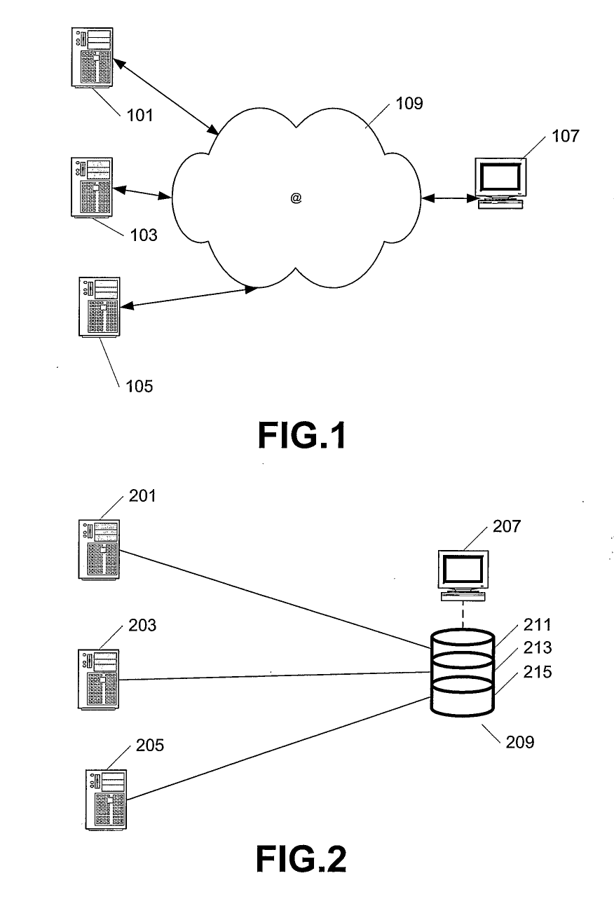

FIG. 1 illustrates a number of broadcasters or websites providers communicating with a client,

FIG. 2 illustrates cookie access restriction according to the present invention, and

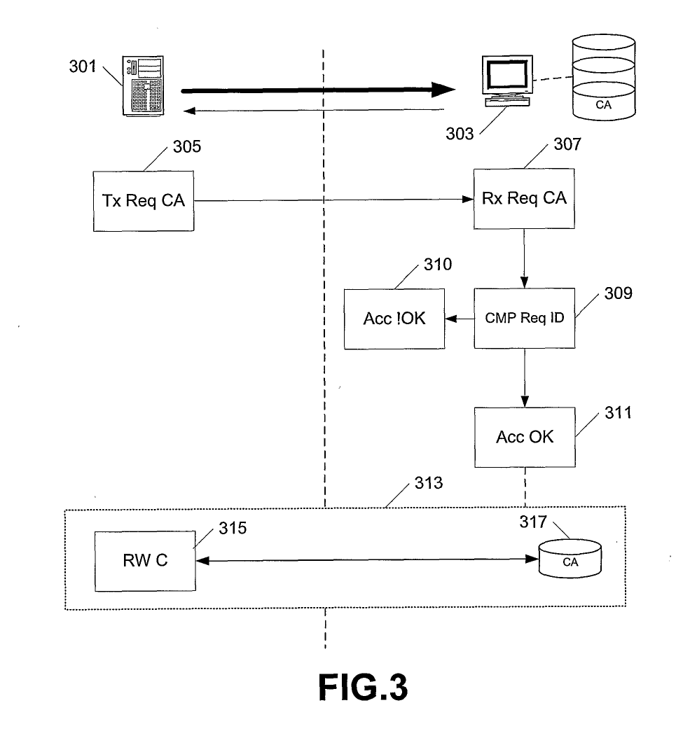

FIG. 3 illustrates a flow diagram of the method of restricting cookie access according to the present invention.

In FIG. 1 a number of broadcasters or websites providers 101, 103, 105 are communicatively connected to a client 107 across a network 109 e.g. being the Internet. The broadcaster could e.g. be broadcasting data being processed by the client 107, e.g. by playing back the data or by recording the data. Besides broadcasting, the broadcaster can also receive information via a return channel, and this channel could e.g. be used to personalize the broadcasted information based on user specific information stored at the client in the form of cookies. The cookies could e.g. comprise information relating to the broadcasted channel or to advertisement web sites e.g. received via the broadcasted channel. The client could be a multimedia home platform MHP enabled set topbox.

To protect the privacy of the user, access to cookies stored on the client is restricted. This access restriction could e.g. be made whereby only MHP applications from the channel wherefrom the cookie originated have access to the cookies, or only ad sites being accessed from a link on the same web site have access to the cookies. In this way the broadcaster or web site provider and the third party service providers can only see cookie information relating to their own web site or service and maybe also websites or services being linked to from the same service provider. When a broadcaster or website wishes to access cookies stored on the client, the broadcaster needs to get permission to access the cookies, which e.g. could be given by the storage API of the client. The underlying software checks if the originator of the cookie is the same as the party requesting info from the cookie. This check is done by checking whether a certificate issued by the broadcaster matches a certificate stored on the client and corresponding to the cookies. If this does not match, then permission is rejected, otherwise access is granted to the cookies and the information stored in the cookies.

In MHP a certification system similar to the one used on the Internet is used to certify the identity of the party that transmitted the application. This is necessary to ensure that the origin of the application is a trusted source (for example a broadcaster), such that the client cannot be hacked by some malicious party. This mechanism could also be used to identify to which cookies a party has access.

A less secure approach is to link cookies to the channels broadcast (these are mapped to channel numbers on the user's remote). This is less flexible in the case where the same broadcaster has multiple channels.

In FIG. 2 the cookie access restriction according to the present invention is illustrated. The client 207 comprises data storage 209 whereon cookies are stored. The broadcasters 201, 203 and 205 each store cookies in restricted areas 211, 213 and 215 of the storage 209. The restriction could be applied by allocating a storage space to cookies relating to applications broadcasted by a specific broadcaster, and then only allowing that broadcaster or applications from that broadcaster to it. So only the applications from the specific broadcaster can read it. The implementation could be to have a secure identification for the application, and then to use this to make sure that only specific applications can access the cookies or access the storage space 211, 213, 215 in which the cookies are stored.

Other types of restriction could be storing multiple cookie files, one per broadcaster, or alternatively each cookie could be tagged with the ID of the broadcaster.

An example where the present invention is used could be if the broadcaster BBC 1 broadcasts an MHP application that gets information from the Internet (www.bbc.co.uk) and this web page includes an embedded link to an advertisement web site (www.ads.com), then the ad web site may store a cookie on the user's disc. Because the application controlling access was received from BBC, the cookie will be in the BBC cookie file or tagged as being from the BBC broadcaster. Now, if MTV broadcasts an MHP application that gets information from the Internet (www.mtv.com), and again it includes a link to an advertisement web site (www.adS.com), then when the ad web site tries to read cookies from the disc, it will only see cookies tagged as being from MTV, thus the ad web site will not see the cookie stored from the BBC application. Thus the ad web site cannot track users across different broadcasters.

FIG. 3 illustrates a broadcaster 301 broadcasting 302 data to a client 303. At 305 the broadcaster 305 wishes to access a cookie stored on the client by transmitting a request to the client. The client receives the request in 307. The underlying system at the client checks if the originator of the cookie is the same as the party requesting info from the cookie. This is done in 309 by comparing a certificate or ID relating to the requesting broadcaster with the ID or certificates corresponding to the cookie. If these do not match, then permission is rejected 310. If they do match 311, then access to the cookie and to the information in the cookie is granted. This is illustrated in 313 where the broadcaster 301 has access to read and write 315 to the cookie stored on the storage 317 of the client 303.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, by means of a suitably programmed computer, a computer programme or a computer readable medium. In a device claim enumerating several means, several of these means can be embodied by one and the same item of hardware. The mere fact that certain measures are recited in mutually different dependent claims does not indicate that a combination of these measures cannot be used to advantage.

1. A method of restricting access to cookie information stored on a client, said client being communicatively connected to servers via a public communication network, wherein the client receives first party data from said server, said first party data comprising embedded links to third party data objects, where at least one of said data objects is adapted for storing client specific cookie information relating to said third party data object on said client, the method comprises the step of:
restricting access to said stored cookie information, whereby only third party data objects have access to said cookie information if the third party data objects are accessed via a link from said first party data.

2. A method according to claim 1, wherein the access to said cookie information is restricted by tagging the stored cookie information with an ID of the first party data, whereby the ID is used to ensure that only third party data objects accessed via a link from said first party data have access to the cookie information.

3. A method according to claim 1, wherein the access to said cookie information is restricted by generating a specific cookie file, whereby only third party web pages being accessed via a link from said first party data have access to said cookie file.

4. A method according to claim 1, wherein the first party data is a web page.

5. A method according to claim 1, wherein the first party data is a broadcasted channel.

6. A method according to claim 1, wherein the client is a MHP client, and wherein the identification system of the MHP used for identifying the server such as a broadcaster is further used for checking whether a third party application has access to said cookie information.

7. A client adapted for being communicatively connected to servers via a public communication network, wherein the client is adapted for receiving first party data from said server, said first party data comprising embedded links to third party data objects, where at least one of said data objects is adapted for storing client specific cookie information relating to said third party web page on said client, the client comprises:
means for restricting access to said cookie information, whereby access to said cookie information is restricted to third party data objects being accessed via a link from said first party data.

8. Computer programme comprising instructions for programming a computer to enable the computer to execute the method of claim 1.

9. Computer programmed to be able for execute the method of claim 1.

10. Computer readable medium having stored thereon the computer programme of claim 8.
